(19) United States
(12) Patent Application Publication
(10) Pub. No.: US 2008/0091814 A1
(43) Pub. Date: Apr. 17, 2008

(54) Network Connection Fast Recovery

(76) Inventor: Tao Xie, Fremont, CA (US)

Correspondence Address: MARSHALL, GERSTEIN & BORUN, LLP (MARVELL), 233 SOUTH WACKER DRIVE, 6300 SEARS TOWER, CHICAGO, IL, 60606-6357, US

(21) Appl. No.: 11/870,952

(22) Filed: Oct. 11, 2007

Related U.S. Application Data
(60) Provisional application No. 60/829,626, filed on Oct. 16, 2006.

(51) Int. Cl. G06F 15/16

(52) U.S. Cl. 709/223

(57) ABSTRACT

A network connection that uses a connection protocol for discovery, operation, and tear-down may call for a server timeout period when the network connection is abnormally terminated. For example, when a tear-down message is not transmitted to end a session when a fault occurs, a server device may require a time-out period to expire before a reconnection is allowed. A client device starting a new session may store connection details from the most recent session and send the tear-down message associated with the previous session to interrupt any current timeout period caused by a previous bad disconnect. If the tear-down message is not applicable, it is ignored by the server-side device. The process of sending a tear-down message of a previous session prior to sending a new session initiation message may be particularly applicable to a point-to-point protocol over Ethernet (PPPoE) connection.

### RELATED APPLICATION

This application claims priority to U.S. Provisional Application No. 60/829,626, entitled “PPPoE CONNECTION FAST RECOVERY,” filed on Oct. 16, 2006, which is hereby incorporated by reference herein in its entirety.

### FIELD OF TECHNOLOGY

The present disclosure relates generally to communication devices, and more particularly, to techniques for shortening a connection timeout periods for improperly terminated communication sessions.

### DESCRIPTION OF THE RELATED ART

A network connection between a client and a server, particularly a network connection over a public network, often uses a protocol that defines the signaling required to establish, maintain, and tear down the connection. Many such connection types exist, for example, dial-up modem connections, digital subscriber line (DSL) connections, and broadband cable connections are all examples of network connections in common use. Each has one or more protocols associated with its use, such as the v.42 dial-up modem connection standard, the “Point-to-Point Protocol over Ethernet (PPPoE) for DSL connections, and the “Data Over Cable Service Interface Specification” (DOCSIS) for broadband cable connections. As will be discussed in more detail below, these protocols specify not only what each side is required to do during normal operation, but also, what measures to take when the connection breaks unexpectedly and does not have a chance to go through a normal, orderly exit.

In one such abnormal termination scenario, the server-side process may be required to refuse further connection requests from that client for a timeout period. The timeout period can allow the client time to recover from any local errors, but perhaps more importantly, can protect the server-side process from denial of service (DOS) attacks or other malicious activity.

### SUMMARY

A modified network connection protocol allows a client device to end a server-side timeout period by sending a connection termination message associated with a previous, incorrectly terminated session. The client device may store session connection data needed to generate the connection termination message.

When the server process receives the connection termination message for the broken session, it may immediately end the timeout period and listen for new connection requests. If no timeout period is active and a connection termination message is received, the server process may simply ignore the connection termination message.

In one embodiment session data corresponding to a previous data communication session with a server device is stored and when no data communication session is active, the stored session data may be used to send a session termination message for the previous data communication session. A session initiation message may then be sent corresponding to a new session.

In another embodiment, a device supporting a point-to-point protocol over Ethernet (PPPoE) may have a memory that stores session data from a last session and uses it to send a session termination message to a server before initiating a new session with the server.

### BRIEF DESCRIPTION OF THE DRAWINGS

FIG. 1 is a simplified and representative block diagram of a client-server network connection;

FIG. 2A is a simplified protocol diagram for a representative prior art client-server connection with normal termination;

FIG. 2B is a simplified protocol diagram for a representative prior art client-server connection with an abnormal termination;

FIG. 3 is a simplified protocol diagram for a representative client-server connection using fast recover;

FIG. 4A is a flow chart illustrating a method of executing fast recovery of client-server connection on a server-side device;

FIG. 4B is a flow chart illustrating a method of executing fast recovery of client-server connection on a client-side device; and

FIGS. 5A-5E illustrate exemplary embodiments incorporating network connection fast recovery.

### DETAILED DESCRIPTION

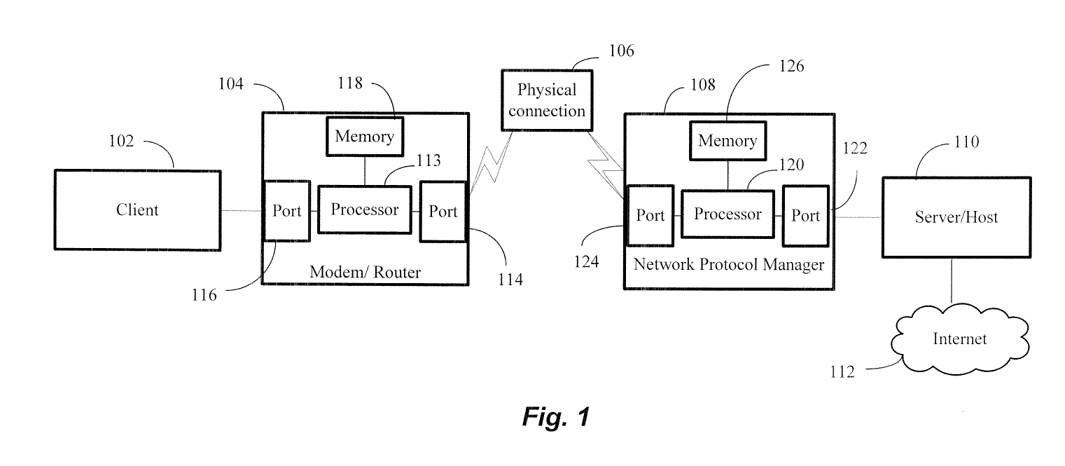

FIG. 1 is a simplified and representative block diagram of a client-server network connection.

A client device 102 may use a modem 104 to connect via a physical network 106 to a network protocol manager 108. The network protocol manager 108 may manage network traffic between the client 102 and a server or host 110 that may provide connection to a wide area network, such as the Internet 112.

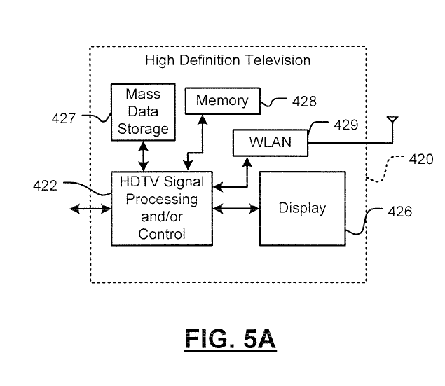

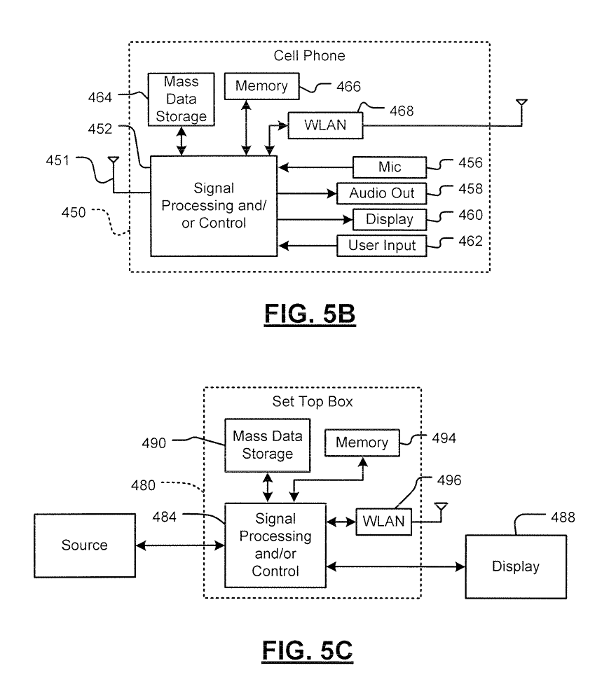

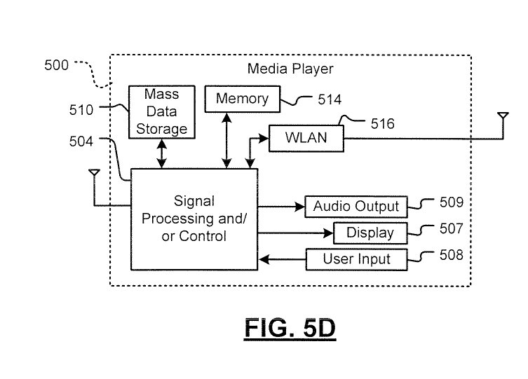

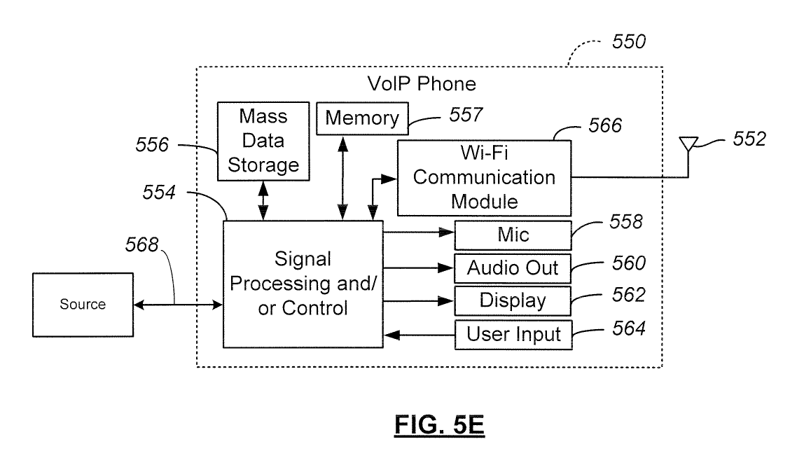

The client 102 may be any electronic device that connects to a network, such as a personal computer, personal digital assistant (PDA), smart phone, any of the exemplary devices described in FIGS. 5A-5E, etc. The modem 104 may be external to the client device 102, such as an external DSL or cable modem, or may be internal such as may be the case in a portable device, such as a smart phone.

The physical connection 106 is supported by a physical interface or interfaces available at the modem 104. For example, a cable modem supports traffic over a cable television connection, whereas a DSL modem supports traffic over a telephone line connection. The physical connection 106 may be a cable television connection, a telephone connection, a 3G wireless connection, a WiFi connection, etc. In some embodiments, more than one hop may be needed to reach a particular server or host 110. For example, a WiFi connection in a coffee shop may connect first to a local network protocol manager for the wireless session and then may connect via a broadband wired connection to a second network protocol manager (not depicted) in order to reach the server or host 110.

As with the modem 104, the network protocol manager 108 is capable of supporting the physical connection 106 associated with the data connection to the modem 104. The server or host 110 may be a back-end supporting service, such as an Internet service provider (ISP) or may be a destination, such as a sales support system for an enterprise or entertainment programming for a music service. The connection to the Internet 112 may be optional, depending on the type of relationship the client 102 has with the server or host 110. For example, if the server or host is an enterprise server, the employee-users may not have access to the Internet 112 via the server or host 110.

The modem 104 may include a processor 113 and communication ports 114 and 116 for coupling to the physical connection 106 and the client 102, respectively. In some embodiments, particularly when the modem 104 includes a router function, multiple client-side ports, such as port 116, may exist. A memory 118 may store executable instructions and data, such as protocol data and session information, as described in more detail below. The memory 118 may include volatile memory, non-volatile memory, or both. Examples of non-volatile memory include hard disk drives, flash memory, NVRAM, and EEPROM, to name a few.

The network protocol manager 108 may include a processor 120, communication ports 122 and 124 for connection to the server or host 110 and the physical connection 106, respectively. The processor may also be coupled to a memory 126 that stores executable instructions and data, such as protocol data and session information. A memory 118 may store executable instructions and data, such as protocol data and session information, as described in more detail below. The memory 126 may include volatile memory, non-volatile memory, or both. Examples of non-volatile memory include hard disk drives, flash memory, NVRAM, and EEPROM.

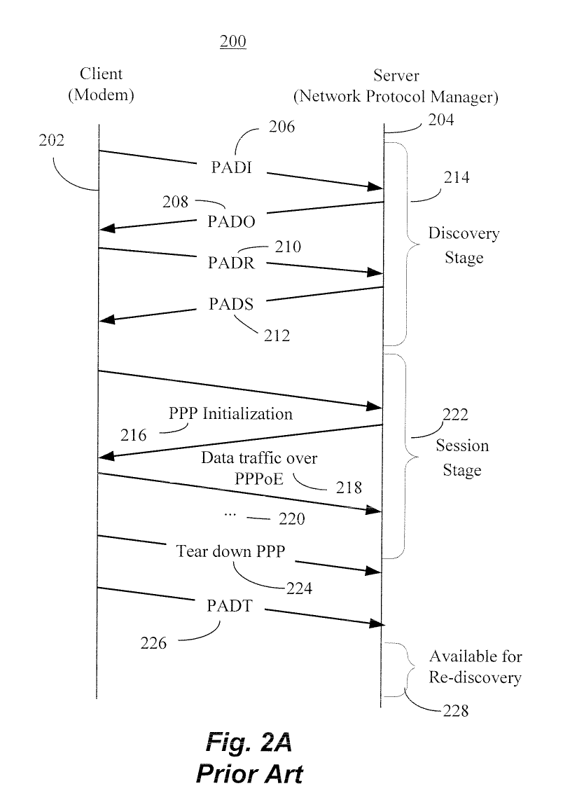

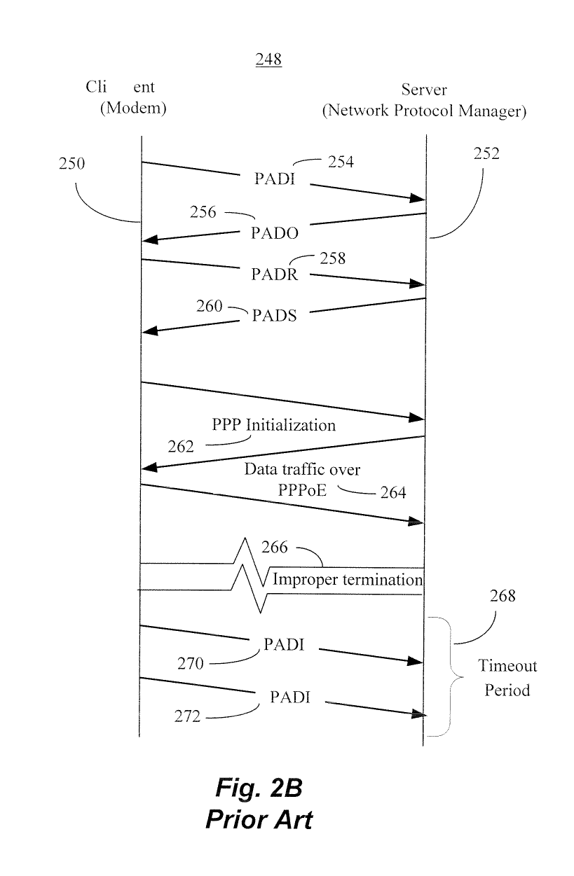

FIG. 2A is a protocol diagram for a representative prior art client-server connection with a normal termination. For ease of explanation, a typical communication protocol often used for a digital subscriber line (DSL) communication session, known as a point-to-point protocol over Ethernet (PPPoE) will be described. The example of FIG. 2A illustrates a typical discovery, setup, operation, and termination of a connection in many common communication protocols. Communication received by and sent from a client, such as the modem 104 of FIG. 1, are represented by a time line 202. Communication received by and sent from a server-side device, such as the network protocol manager 108 of FIG. 1 are represented by a time line 204.

A first message 206 may be sent from the client 202 to the server 204. The first message 206 may be an initial request for connection. For the exemplary protocol, the message may be a PPPoE Active Discovery Initiation (PADI) message. The PADI message may include a media access control (MAC) address of the client, that is, a hardware-oriented address either assigned by a manufacturer or set during a configuration cycle. A second message 208 from the server 204 to the client 202 may be a PPPoE Active Discovery Offer (PADO) message which is sent in response to the PAD message 206. The PADO message 208 may contain the MAC address of the client, as well as a MAC address of a server-side entity, such as a DSL access concentrator (roughly equivalent to the network protocol manager 108 of FIG. 1). It may also include a session identifier, which is, in one embodiment, a 4 digit sequence number that increases with each session and rolls over at 9999 to 0000. A typical PADO message is shown in Table 1 below. Src: 00:0e:20:7f:f3:7a is the server MAC address, whereas Dst: 00:52:db:4a:d7:ed is the client MAC address.

TABLE 1

| Message Contents | Explanation |
|---|---|
| Frame (60 bytes on wire) | Indicates the overall message is 60 |
| | bytes. |
| Ethernet II, Src: 00:0e:20:7f:f3:7a, | Defines address type and the |
| Dst: 00:52:db:4a:d7:ed | source and destination addresses |
| | in hexadecimal format |
| PPP-over-Ethernet Discovery | The message type |
| Version: 1 | The version for the PPPoE |
| | Discovery message |
| Type 1 | The type of the PPPoE Discovery |
| | message |
| Code Active Discovery Offer | The type of PPPoE Discovery |
| (PADO) | message, that is, a PADO message |
| Session ID: 0000 | The session identifier, each |
| | session between this server and |
| | client increases the count by one |
| Payload Length: 36 | The byte count of the message |
| | payload |
| PPPoE Tags | Identifies the beginning of the tag |
| | section |
| Tag: Service-Name | A first name tag |
| Tag: AC-Name | A second name tag |
| String Data: IpzbrOOl | A string representing the Name |
| | tag |
| Tag: Host-Uniq | A third name tag |
| Binary Data: (16 bytes) | 16 bytes of binary data that may |
| | include authentication bits, |
| | routing information, etc. |

More than one server may respond to the PADI message with PADO messages, thereby offering their services. The client may determine which of the servers it wishes to connect with and may send a third message 210, a PPPoE Active Discovery Request (PADR) message to the chosen server 204. The PADR message will include the MAC address of the selected server. The chosen server 204 may then confirm the selection by sending a fourth message 212, a PPPoE Active Discovery Session-confirmation (PADS) message in response to the PADR message 210.

The messages 206, 208, 210 and 212 make up the discovery stage of the PPPoE session. The discovery stage includes the client 202 finding and selecting a server 204 and the server 204 identifying itself and accepting a session with the client 202. A session stage 222 establishes the point-to-point protocol on top of the Ethernet communication used for discovery and supports normal data traffic between the client 202 and the chosen server 204. For example, the session stage may begin with a number of point-to-point (PPP) messages 216, after which standard data traffic 218 may be supported, represented by ellipsis 220. To relate to the exemplary embodiment of FIG. 1, the modem 104 may take a certain amount of time to connect and log in before user traffic, such as web browsing can be supported. In some typical modems, the front panel lights may blink yellow during the discovery and initial portions of the session stages.

To leave the session stage 220, either side may tear down the PPP session, represented by a tear down message 224. The tear-down process returns client and server pointers and registers to their quiescent state, that is, hardware and software resources used by both sides during the session may be deactivated or unlocked, so that they may used again for another session, between the same parties or between different parties. To illustrate a client-initiated teardown, a fifth message 226, such as a PPPoE Active Discovery Termination (PADT) message may be sent from the client 202 to the chosen server 204. Upon receiving the PADT message, the chosen server 204 is available for re-discovery by the client 202, as indicated by bracket 228.

FIG. 2B illustrates the process when an error occurs. FIG. 2B is a simplified protocol diagram for a representative prior art client-server connection 248 with an abnormal termination. As above, the diagram illustrates messages on a client timeline 250 and a server timeline 252. A PADI message 254 from the client is followed by a PADO message 256 from the server 204. A request is made by the client with a PADR message 258 and the session is confirmed by a PADS message 260 from the server 204. A session stage may include PPP initialization messages 262 and data traffic messages 264.

At some point in the set up or data traffic phases of the session, an improper termination event 266 may occur. The improper termination event 266 may be a loss of connectivity over the physical connection, a power outage at a modem or protocol manager, etc. Other improper termination events 266 may include packet synchronization errors, timeout errors, loss of connectivity between with endpoints, etc. Among other effects of the improper termination event 266, no termination message is sent, such as the teardown message 224 of the PADR message 226 of FIG. 2A.

Following an improper termination event 266, the server 204 may impose a timeout period 268, during which incoming PADI messages 270 and 272 from the client are ignored. The timeout period may provide some protection from a denial of service (DOS) attack if multiple clients are spoofing a MAC address and sending multiple PADI messages. At the conclusion of the timeout period 268, PADI messages may again be accepted at the server-side 252.

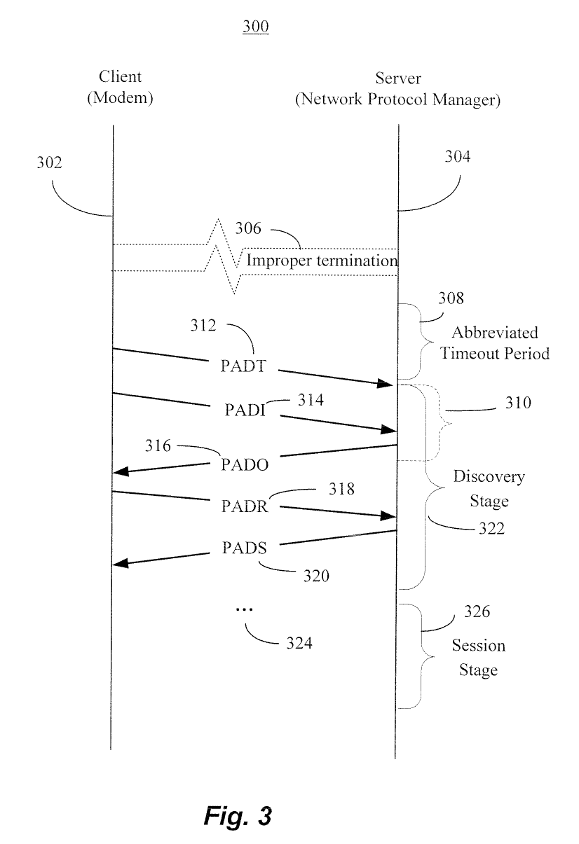

FIG. 3 is a simplified protocol diagram for a representative client-server connection using a fast recovery technique. A session 300 may proceed according to the protocol in use, such as, the prior art protocol illustrated in FIG. 2A. The client-side timeline 302 and the server-side timeline 304 represent message endpoints sent between client and server entities such as those shown in FIG. 1. At some point after an exchange of MAC identities, an improper termination 306 may occur. A timeout period may be started on the server-side 304. The total time originally allocated for the timeout period may be represented by the sum of time periods 308 and 310. However, a PADT message 312, with information corresponding to the session that ended at the improper termination 306, may be sent from the client-side 302 to the server-side 304 that can shorten the timeout period, to the time 308 only. This allows the beginning of the discovery stage 322 to advance to the end of the shortened timeout period 308, and bypass the remaining timeout period represented by time period 310.

Because only the genuine client 302 is likely to have both the MAC address of the server and the session identifier of the previous session (see Table 1, above), the server 304 is at a low risk of a DOS attack. The server 304 may determine that the PADT message 312 is genuine by comparing the session information in the message 312 to locally-stored information about previous sessions for known client-side devices. If the PADT session information matches, the PADT message 312 may be considered as representing the missing termination message from the previous, improperly terminated session. The total timeout period, periods 308 plus 310, may then be terminated immediately after the first portion of the timeout period 308, shortened by the unexpended timeout period 310. A PADI message 314 may then be accepted, starting a new session discovery stage 322, often saving several seconds or more of reconnection time.

The remainder of the flow may be followed as normal, including a PADO message 316, a PADR message 318, and a PADS message 320. The session stage 326 may include message traffic 324 such as described above.

In some embodiments, the PADT message 312, with information about the previous session, may be sent even if no timeout period is active because either the previous session terminated normally, as shown in FIG. 2A, or the timeout period already expired. To illustrate this in FIG. 3, the improper termination 306 is shown dotted, indicating that it may or may not occur prior to sending the PADT message 312. In another embodiment, the client-side 302 may have knowledge of the timeout period duration, and may only send a PADT message 310 when the timeout period is likely to be active. In yet another embodiment, the PADT message 310 may be sent only after an initial PADI message has been rejected or ignored (such as PADI messages 270 and 272 of FIG. 2B).

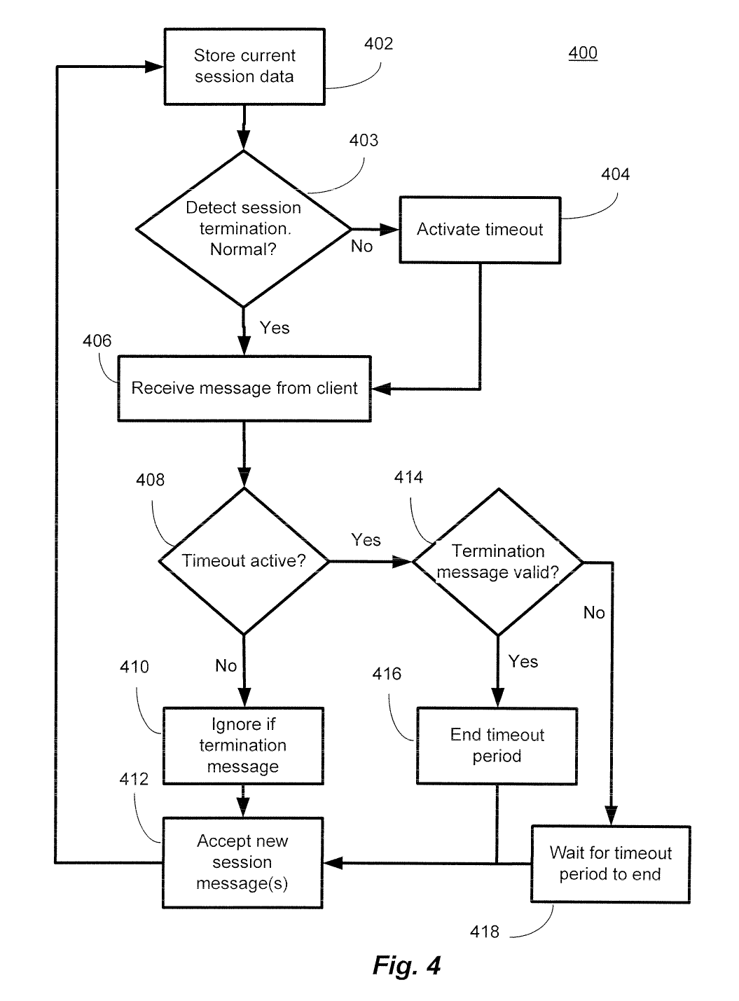

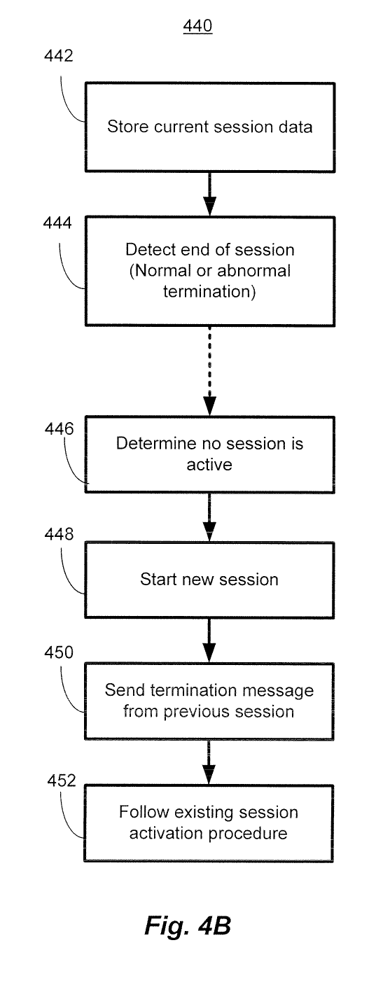

FIG. 4A is a flow chart illustrating an example method 400 for implementing a fast recovery of a client connection on a server device, such as the network protocol manager 108 of FIG. 1. At a block 402, a current session is assumed to be active and current session data including a session identifier and a client device identifier, such as a MAC address, for either a client 102, or a modem 104, may be stored. At a block 403, the server may detect that the current session has ended, either normally or abnormally. If the termination is normal, the ‘yes’ branch from the block 403 may be taken to a block 406, and the network protocol manager 108 may wait to receive an incoming message. If the session abnormally, the ‘no’ branch from the block 403 may be taken to a block 404 where the network protocol manager 108 may activate a timeout timer that runs for a preset period of time.

At a block 406, the network protocol manager 108 may receive a message from a client, for illustration, the client 104 of the session referenced at the block 402. At a block 408, a check may be made to determine if a timeout period is active for the client-side device sending the message. If no timeout period is active for the client device, the “no” branch from the block 408 may be taken to a block 410. At the block 410, the network protocol manager 108 can determine if the message is a termination message and, if so, can simply ignore the termination message and at a block 412, wait for and process session initiation messages from that client device.

If, at the block 408, a timeout period is active for that client device the “yes” branch from the block 408 may be taken to a block 414. If it is determined at the block 414 that the message is a termination message and that the termination message is valid, that is, a session identifier in the termination message matches the session identifier stored at the block 402 for that client device identifier, the “yes” branch from the block 414 may be taken to a block 416 and the timeout period may be stopped immediately. Processing may continue at the block 412 and an incoming session initiation message may be processed normally.

If, at block 414, the termination message is found not to be valid, the “no” branch from block 414 may be taken to a block 418 and the timeout period may be enforced until its scheduled end before continuing to the block 412 to accept a new session message from the client device. Processing may continue at the block 402 and data related to the newly established session may be stored.

FIG. 4B is a flow chart illustrating an example method 440 of implementing a fast recovery of a client/server connection on a client-side device, such as the modem 102 of FIG. 1. At a block 442, a communication session is assumed to be active and current session data may be stored including a client address used for session set up, such as a MAC address, and a session identifier assigned by a server-side device. At a block 444, the client may detect that the communication session has ended, either normally or abnormally. In some cases, the client-side device may take certain steps to recover from an abnormal termination such as clearing data buffers and resetting to an idle state. At some point following the end of the previous session, at a block 446, a determination may be made that no communication session is active. At a block 448, responsive to a request generated in the client or as part of a power cycle, a new communication session may be initiated.

Because the client has no definitive knowledge of the state of a network protocol manager at the server side, that is, whether a timeout period is active, the client may proactively generate and send a termination message for the previous communication session. The goal of sending such termination message is to cut short any active timeout period that may be active at the server-side and expedite the establishment of the new communication session. At a block 450, data stored regarding the previous communication session at the block 442 may be used to generate a session termination message for the previous session. For example, in one embodiment, a PADT message using data stored at the block 442 may be generated and sent to the server-side device. For simplicity, sending a session termination message for the previous session at the beginning of a new session may be done whether or not the previous session was normally terminated or not. In another embodiment, the client-side device, such as the modem 102, may determine if a time period between the blocks 444 and 446 is known to be longer than a server-side device timeout period. If so, and a timeout period could not be active at the server-side device, then the client may choose not to send the session termination message for the previous session because it would have no effect.

At a block 452, the protocol for establishing a new session may be followed. In one embodiment, a PADI message may be sent to begin the new session establishment procedure.

The embodiment described uses PPPoE to illustrate the proactive use of a session termination message to reduce session connection times. However, the technique applies equally to any other communication session where a timeout period may be activated if a communication session is not properly terminated.

FIGS. 5A-5E, illustrate various devices in which fast recovery from a connection termination techniques, such as described above may be implemented. Referring now to FIG. 5A, such techniques may be utilized in a high definition television (HDTV) 420. HDTV 420 includes a mass data storage 427, an HDTV signal processing and control block 422, a WLAN interface 429 and memory 428. HDTV 420 receives HDTV input signals in either a wired or wireless format and generates HDTV output signals for a display 426. In some implementations, signal processing circuit and/or control circuit 422 and/or other circuits (not shown) of HDTV 420 may process data, perform coding and/or encryption, manage communication protocols, perform calculations, format data and/or perform any other type of HDTV processing that may be required. The WLAN interface 429 may implement a fast recover from connection termination method, for example.

HDTV 420 may communicate with mass data storage 427 that stores data in a nonvolatile manner such as optical and/or magnetic storage devices. The mass storage device may be a mini HDD that includes one or more platters having a diameter that is smaller than approximately 1.8″. HDTV 420 may be connected to memory 428 such as RAM, ROM, low latency nonvolatile memory such as flash memory and/or other suitable electronic data storage. HDTV 420 also may support connections with a WLAN via a WLAN network interface 429.

Referring now to FIG. 5B, such fast recovery techniques may be utilized in a cellular phone 450. The cellular phone 450 may include a cellular antenna 451. The cellular phone 450 may include either or both signal processing and/or control circuits, which are generally identified in FIG. 5B at 452, a WLAN interface 468 and/or mass data storage 464 of the cellular phone 450. In some implementations, cellular phone 450 includes a microphone 456, an audio output 458 such as a speaker and/or audio output jack, a display 460 and/or an input device 462 such as a keypad, pointing device, voice actuation and/or other input device. Signal processing and/or control circuits 452 and/or other circuits (not shown) in cellular phone 450 may process data, perform coding and/or encryption, perform calculations, manage communication protocols, format data and/or perform other cellular phone functions. The WLAN interface 468 may implement a fast recover from connection termination method, for example.

Cellular phone 450 may communicate with mass data storage 464 that stores data in a nonvolatile manner such as optical and/or magnetic storage devices for example hard disk drives HDD and/or DVDs. The HDD may be a mini HDD that includes one or more platters having a diameter that is smaller than approximately 1.8″. Cellular phone 450 may be connected to memory 466 such as RAM, ROM, low latency nonvolatile memory such as flash memory and/or other suitable electronic data storage. Cellular phone 450 also may support connections with a WLAN via a WLAN network interface 468.

Referring now to FIG. 5C, such fast recover techniques may be utilized in a set top box 480. The set top box 480 may include either or both signal processing and/or control circuits, which are generally identified in FIG. 5C at 484, a WLAN interface 496 and/or mass data storage 490 of the set top box 480. Set top box 480 receives signals from a source such as a broadband source and outputs standard and/or high definition audio/video signals suitable for a display 488 such as a television and/or monitor and/or other video and/or audio output devices. Signal processing and/or control circuits 484 and/or other circuits (not shown) of the set top box 480 may process data, perform coding and/or encryption, perform calculations, manage communication protocols, format data and/or perform any other set top box function.

Set top box 480 may communicate with mass data storage 490 that stores data in a nonvolatile manner. Mass data storage 490 may include optical and/or magnetic storage devices for example hard disk drives HDD and/or DVDs. The HDD may be a mini HDD that includes one or more platters having a diameter that is smaller than approximately 1.8″. Set top box 480 may be connected to memory 494 such as RAM, ROM, low latency nonvolatile memory such as flash memory and/or other suitable electronic data storage. Set top box 480 also may support connections with a WLAN via a WLAN network interface 496. The fast recover from connection termination method may be implemented in the signal processing and/or control circuits 484, the WLAN network interface 496, or both, for example.

Referring now to FIG. 5D, such fast recover techniques may be utilized in a media player 500. The media player 500 may include either or both signal processing and/or control circuits, which are generally identified in FIG. 5D at 504, a WLAN interface 516 and/or mass data storage 510 of the media player 500. In some implementations, media player 500 includes a display 507 and/or a user input 508 such as a keypad, touchpad and the like. In some implementations, media player 500 may employ a graphical user interface (GUI) that typically employs menus, drop down menus, icons and/or a point-and-click interface via display 507 and/or user input 508. Media player 500 further includes an audio output 509 such as a speaker and/or audio output jack. Signal processing and/or control circuits 504 and/or other circuits (not shown) of media player 500 may process data, perform coding and/or encryption, perform calculations, manage communication protocols, format data and/or perform any other media player function. The WLAN interface 516, the signal processing and/or control circuits 504, or both, may implement the fast recover from connection termination method, for example.

Media player 500 may communicate with mass data storage 510 that stores data such as compressed audio and/or video content in a nonvolatile manner. In some implementations, the compressed audio files include files that are compliant with MP3 format or other suitable compressed audio and/or video formats. The mass data storage may include optical and/or magnetic storage devices for example hard disk drives HDD and/or DVDs. The HDD may be a mini HDD that includes one or more platters having a diameter that is smaller than approximately 1.8″. Media player 500 may be connected to memory 514 such as RAM, ROM, low latency nonvolatile memory such as flash memory and/or other suitable electronic data storage. Media player 500 also may support connections with a WLAN via a WLAN network interface 516. Still other implementations in addition to those described above are contemplated.

Referring to FIG. 5E, such fast recover techniques may be utilized in a Voice over Internet Protocol (VoIP) phone 550 that may include an antenna 552. The VoIP phone 550 may include either or both signal processing and/or control circuits, which are generally identified in FIG. 5E at 554, and may include network connection 568, and/or mass data storage of the VoIP phone 556. In some implementations, VoIP phone 550 includes, in part, a microphone 558, an audio output 560 such as a speaker and/or audio output jack, a display monitor 562, an input device 564 such as a keypad, pointing device, voice actuation and/or other input devices, and a Wireless Fidelity (Wi-Fi) communication module 566. Signal processing and/or control circuits 504 and/or other circuits (not shown) in VoIP phone 550 may process data, perform coding and/or encryption, perform calculations, manage communications protocols, format data and/or perform other VoIP phone functions. The WiFi communication module 508, the signal processing and/or control circuits 504, or both, may implement the fast recover from connection termination method, for example.

VoIP phone 550 may communicate with mass data storage 556 that stores data in a nonvolatile manner such as optical and/or magnetic storage devices, for example hard disk drives HDD and/or DVDs. The HDD may be a mini HDD that includes one or more platters having a diameter that is smaller than approximately 1.8″. VoIP phone 550 may be connected to memory 557, which may be a RAM, ROM, low latency nonvolatile memory such as flash memory and/or other suitable electronic data storage. VoIP phone 550 is configured to establish communications link with a VoIP network (not shown) via the Wi-Fi communication module 566.

The various blocks, operations, and techniques described above may be implemented in hardware, firmware, software, or any combination of hardware, firmware, and/or software. When implemented in software, the software may be stored in any computer readable memory such as on a magnetic disk, an optical disk, or other storage medium, in a RAM or ROM or flash memory of a computer, processor, hard disk drive, optical disk drive, tape drive, etc. Likewise, the software may be delivered to a user or a system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software may be delivered to a user or a system via a communication channel such as a telephone line, a DSL line, a cable television line, a wireless communication channel, the Internet, etc. (which are viewed as being the same as or interchangeable with providing such software via a transportable storage medium). When implemented in hardware, the hardware may comprise one or more of discrete components, an integrated circuit, an application-specific integrated circuit (ASIC), etc.

While the present invention has been described with reference to specific examples, which are intended to be illustrative only and not to be limiting of the invention, it will be apparent to those of ordinary skill in the art that changes, additions or deletions in addition to those explicitly described above may be made to the disclosed embodiments without departing from the spirit and scope of the invention.

We claim:

1. A method comprising:
storing session data corresponding to a previous data communication session at a client device;
determining no data communication session is active with a server device;
sending a session termination message from the client device to the server device using the session data corresponding to the previous data communication session; and
sending a session initiation message from the client device to the server device.

2. The method of claim 1, wherein the session data comprises a source address and a session identifier.

3. The method of claim 1, wherein determining no data communication session is active comprises determining at the server device when a data communication session has been active within a session timeout period.

4. The method of claim 1, wherein storing session data comprises storing a source address from a session offer message.

5. The method of claim 1, wherein storing session data comprises storing a session identifier from a session confirmation message.

6. The method of claim 1, furthering comprising terminating the previous data communication session without sending a corresponding session termination message.

7. The method of claim 1, wherein the client device comprises one of a personal computer, a digital subscriber line (DSL) modem, a DSL router, a set-top box, a digital video recorder (DVR), and Voice-over-Internet Protocol phone.

8. The method of claim 1, wherein the data communication session is point-to-point protocol over Ethernet (PPPoE) connection and the session termination is a PPPoE Active Discovery Termination (PADT) message, and the session initiation message is a PPPoE Active Discovery Initiation (PADI) message.

9. A device supporting a point-to-point protocol over Ethernet (PPPoE) data connection comprising:
a port for communicating with a PPPoE host device;
a memory storing computer-executable instructions and data, the data including session data from a last PPPoE connection; and
a processor executing the computer-executable instructions for sending a PADT message corresponding to the last PPPoE connection prior to sending a PADI message initiating a new PPPoE connection.

10. The device of claim 9, wherein the PPPoE host device is a digital subscriber line (DSL) access concentrator.

11. The device of claim 9, wherein the port is a DSL port.

12. The device of claim 9, further comprising a downstream port coupled to a terminal device.

13. The device of claim 12, wherein the terminal device is one of a personal computer, a digital subscriber line (DSL) modem, a DSL router, a set-top box, and a digital video recorder (DVR).

14. The device of claim 9, wherein the memory is a non-volatile memory.

15. A computer-readable medium having computer-executable instructions for executing a method comprising:
receiving a shutdown message corresponding to a previous network session that is no longer active; and
receiving a network session initiation message for activating a new network session;
responding to the network session initiation message according to a predetermined protocol.

16. The computer-readable medium of claim 15, wherein the method further comprises discontinuing a timeout period associated with the previous network session, the timeout period activated responsive to an improper termination of the previous network session.

17. The computer-readable medium of claim 15, wherein receiving the shutdown message comprises receiving the shutdown message including context information corresponding to the previous network session.

18. The computer-readable medium of claim 15, wherein receiving the network session initiation message comprises receiving a point-to-point protocol over Ethernet (PPPoE) Active Discovery Initiation message.

19. The computer-readable medium of claim 15, wherein receiving the shutdown message comprises receiving a PPPoE Active Discovery Termination message.

20. A computer-readable medium having computer-executable instructions for executing a method comprising:
sending a shutdown message corresponding to a previous network session that is no longer active; and
sending a network session initiation message for activating a new network session following sending the shutdown message.

21. The computer-readable medium of claim 20, wherein the method further comprises storing context information in a non-volatile memory corresponding to the previous network session while the previous network session was active.

22. The computer-readable medium of claim 21, wherein sending the shutdown message comprises sending the shutdown message including context information corresponding to the previous network session.

23. The computer-readable medium of claim 20, wherein sending the network session initiation message comprises sending a point-to-point protocol over Ethernet (PPPoE) Active Discovery Initiation message.

24. The computer-readable medium of claim 20, wherein sending the shutdown message comprises sending a PPPoE Active Discovery Termination message.

25. A network session management device supporting shortened timeout periods for broken communication sessions comprising:
a port for coupling to a client device using a communication session protocol;
a memory for storing session data corresponding to a previous session that is no longer active and computer-executable instructions for implementing the communication session protocol; and
a processor coupled to the port and the memory for executing the computer-executable instructions wherein the processor terminates a communication session protocol timeout after receiving a termination message corresponding to a previously disconnected session.

26. The network session management device of claim 25, wherein the processor further executes computer-executable instructions for ignoring the termination message corresponding to the previously disconnected session when no timeout period is active.
